(19) United States
(12) Patent Application Publication
(10) Pub. No.: US 2005/0120207 A1
(43) Pub. Date: Jun. 2, 2005

(54) Method and system for enabling PKI in a bandwidth restricted environment

(76) Inventors: John Hines, San Mateo, CA (US); Piyush Jain, Milpitas, CA (US); Stefan Kotes, Cupertino, CA (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 10/726,841

(22) Filed: Dec. 2, 2003

(51) Int. Cl. H04L 9/00

(52) U.S. Cl. 713/158

(57) ABSTRACT

A PKI mechanism is facilitated in a bandwidth-limited distributed environment by creating a periodic chain of PKI related updates. Changes in CRLs are reflected by periodically created DeltaCRL objects that are part of a continuous chain. The DeltaCRL objects allow for the iterative generation of an updated CRL from a known base CRL within the timeframe of the DeltaCRL chain. Updating of CRL data at bandwidth-limited remote nodes of the distributed environment is facilitated by transmitting a relatively small data object instead of transmitting a complete and bandwidth-taxing updated CRL.

### FIELD OF THE INVENTION

The present invention relates to computer security, and more particularly to facilitating a public key infrastructure in a bandwidth restricted environment.

### BACKGROUND OF THE INVENTION

A Public Key Infrastructure (“PKI”) environment is one in which a plurality of communicating nodes employ certificates containing encryption keys and identification information to ensure that communication between nodes is secure. Examples of such keys are security keys used to operate high security computer systems, which are associated with at least one certificate. An example standard certificate is the X.509 protocol certificate. These certificates are issued and revoked by registration organizations generally referred to as Certificate Authorities (“CAs”).

As may be appreciated, a particular CA grants and revokes certificates on an ongoing basis. A certificate that has been valid yesterday, or perhaps a few hours ago, may not be valid when it is time to employ its data to facilitate the PKI environment. Hence, an organization employing PKI should consider whether a presented certificate is valid prior to allowing a PKI controlled transaction. The validity check is typically by reference to a periodically updated list of revoked or newly issued certificates, which is generally referred to as a Certificate Revocation List (CRL). The update period for each CRL depends on the level of security provided by the corresponding CA. Accordingly, when a user attempts to employ authentication by reference to a certificate, the system receiving the authentication request must ensure that the certificate is valid. This validity check involves a query to the CRL of the certificate issuing entity. One method for querying the CRL is by reference to a local database of CRLs, one for each issuing CA. Since the CRLs are periodically updated by each issuing CA, the local database, must also be periodically updated. The typical method for updating CRLs is by periodic downloading of updated copies for CRLs, when made available by the various CAs or enterprise central office. This method is highly taxing in a bandwidth restricted environment where CRL downloading consumes valuable bandwidth, which may be required by other applications or processes. Therefore, there is a need for a method of maintaining up to date CRLs in various distributed nodes implementing a PKI scheme, which does not require significant bandwidth consumption.

### SUMMARY OF THE INVENTION

The present invention overcomes the bandwidth restriction by the preprocessing of newly issued CRLs to generate a very small data structure which is transmitted to low bandwidth nodes and is employed to generate and verify the integrity of the newly issued CRL. The method includes receiving a new CRL from a certificate authority and generating a difference data file (herein Delta CRL) from the new CRL and the last issued CRL. The method also includes providing the CRL to a server in response to a request for a CRL update. Finally, the method generates an updated CRL by employing a previous CRL and any subsequent DeltaCRLs. Add claims.

In one embodiment, the present invention provides a method for updating CRL information between distributed components in a PKI environment. The method sequentially receives a plurality of periodically updated versions of a CRL associated with a certificate authority. The method generates a plurality of DeltaCRL data elements by reference to sequentially adjacent CRL versions from the received CRL versions. The method provides the DeltaCRLs to a node in a distributed PKI environment. Finally, the method causes the node to sequentially apply the DeltaCRLs to a base CRL to provide increasingly updated versions of said CRL, where the base CRL is a version of the CRL within the timeframe of the periodically updated sequence of CRLs.

### BRIEF DESCRIPTION OF THE DRAWINGS

FIG. 1 illustrates typical PKI components and communication links there between;

FIG. 2 illustrates CRL updating in the system of FIG. 1;

FIG. 3 illustrates the system of FIG. 1 as adapted to operate in accordance with the invention;

FIG. 4 is a flow diagram illustrated the operation of a primary validation component of the invention;

FIG. 5 is a flow diagram illustrating an update request transaction between a pair of radiation authority components; and

FIG. 6 is a flow diagram illustrating the assembly of a updated CRL from Pelto CRL data and a prior version of the CRL.

### DETAILED DESCRIPTION OF THE INVENTION

The invention will now be discussed by first examining the structure and operation of a typical distributed system employing PKI and followed by examining a similar distributed system employing CRL updates in accordance with the invention. First, the logical structure and CRL updating operation of a typical distributed system employing PKI is discussed. Next, the logical structure of a distributed system employing CRL updates according to the invention is discussed. The operation of validation authority components associated with a system of the invention, is then discussed by reference to a flow diagrams. Finally, the operation of an exemplary validation authority component, which updates a local CRL database of a remote access point, is discussed by reference to a flow diagram.

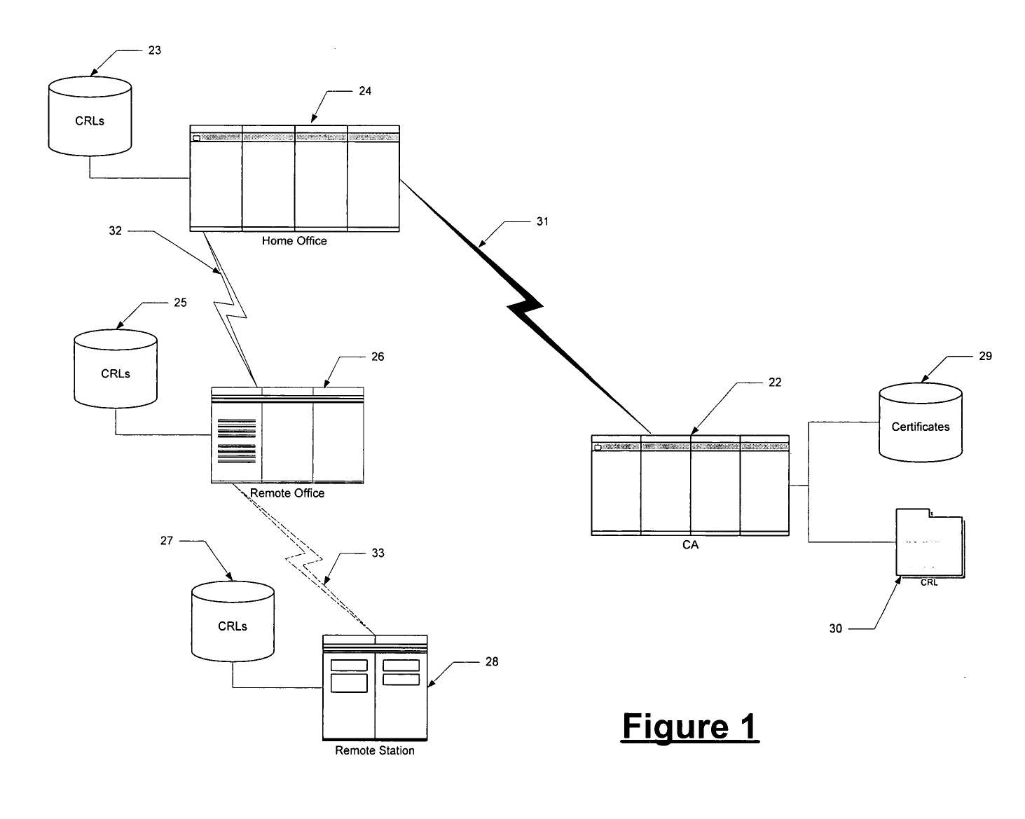

FIG. 1 illustrates components of an exemplary distributed system which employs PKI, including CRL validation. The illustrated system includes enterprise components 24, 26, 28 and a CA 22, which provides certificate generation and maintenance services for the enterprise. As may be appreciated, in some embodiments, the CA is provided by the enterprise and may form part of the enterprise components 24, 26, 28. In other embodiments, the CA 22 is third party controlled, such as a public CA. As may further be appreciated, in a typical enterprise there may be several CAs serving the enterprise. Examples of public CAs include those provided by VERISIGN, and MICROSOFT.

The CA 22 is associated with a certificate database 29 which stores copies of certificates issued by the CA. An example certificate format is provided by the ITU-T recommendation X.509. The main purpose of any certificate is to bind a public key, included in the certificate, with an identity, so that third parties can have some assurance that the name and the public key are bound together. Accordingly, in some configurations, certificates allow for authenticating a public key so as to allow for trusted encryption of communication data. The CA 22 is further associated with a CRL 30. The CRL 30 preferably identifies certificates which have been revoked by the CA 22. For example, an encryption key may have been compromised and can no longer be trusted for communication to the found identity. Accordingly, a user that wants to employ a certificate issued by this particular CA 22 can query the CRL 30 to determine whether a particular certificate has not been revoked. The CRL is preferably self authenticating which does not require the provider and recipient to have a trusted relationship. The CA 22 has available a communication link for communicating with a home office 24 of the enterprise. This communication link 31 is preferably a high bandwidth link.

The illustrated enterprise components include a home office 24, a remote office 25, and a remote station 28. In an example implementation, the home office 24 may be a wagering system at a particular racetrack, the remote office 26 may be an off track betting parlor, while the remote station 28 may be a betting kiosk at a pub. Users of the enterprise components 24, 26, 28 may be individuals or processes executing on server systems at the various component sites. Each of the enterprise components preferably includes at least a CPO, data storage capacity, and communication capacity. The home office 24 preferably has the greatest processing and communication capacity of all components, followed by the remote office 26 and the remote station 28, respectively.

The enterprise users preferably employ PKI to securely communicate data between processes and nodes. The PKI scheme preferably requires revocation and validation inquiry when employing a certificate. Accordingly, in the illustrated embodiment, each component of the enterprise has available a CRL database 23, 25, 27 which stores CRLs from various CAS including the illustrated CA 22. A relatively low bandwidth communication link 32 is provided between the home office 24 and the remote office 26. An example of such link is a modem based telephone link. A much lower bandwidth communication link 33 is provided between the remote office 26 and the remote station 28. An example of such link is a satellite link which may sometimes be unavailable altogether thereby precluding the transmission of the entire CRL.

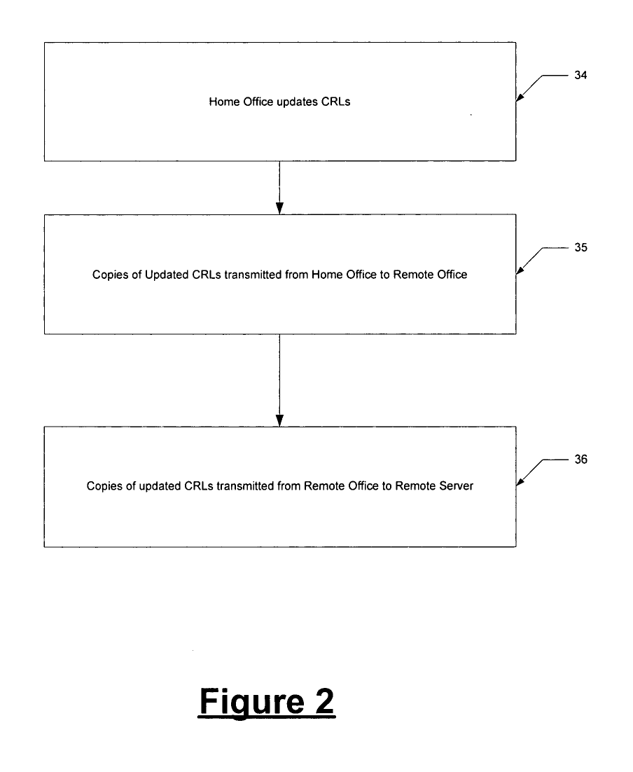

FIG. 2 illustrates typical enterprise component data propagation during local CRL database updating. As is illustrated, after the issuing certificate authority updates the corresponding CRL, the new CRL is sent to a central node of the enterprise. In the illustrated arrangement of FIG. 1, this central node is the home office 24. This transmission is typically over a high bandwidth link and therefore is not highly taxing on system resources. The home office 24 stores the updated CRL in its local CRL database (step 34). At a later time, as determined by the enterprise by reference to the particular PKI scheme employed, the updated CRL is distributed to all remote node, such as the remote office 26 in the illustrated embodiment (step 35). The updating process continues its propagation by the remote node following the same steps as the central node in updating any subordinate nodes with the newly acquired CRL. Accordingly, in the illustrated embodiment, the updated CRL is transmitted from the remote office 26 to the remote server 28 (step 36). As may be appreciated, each such transmission consumes bandwidth. When there are many nodes in the enterprise, and many CAs which serve the enterprise, the bandwidth required to distribute the updated CRLs can be taxing on the communication links, especially those employed by remote servers.

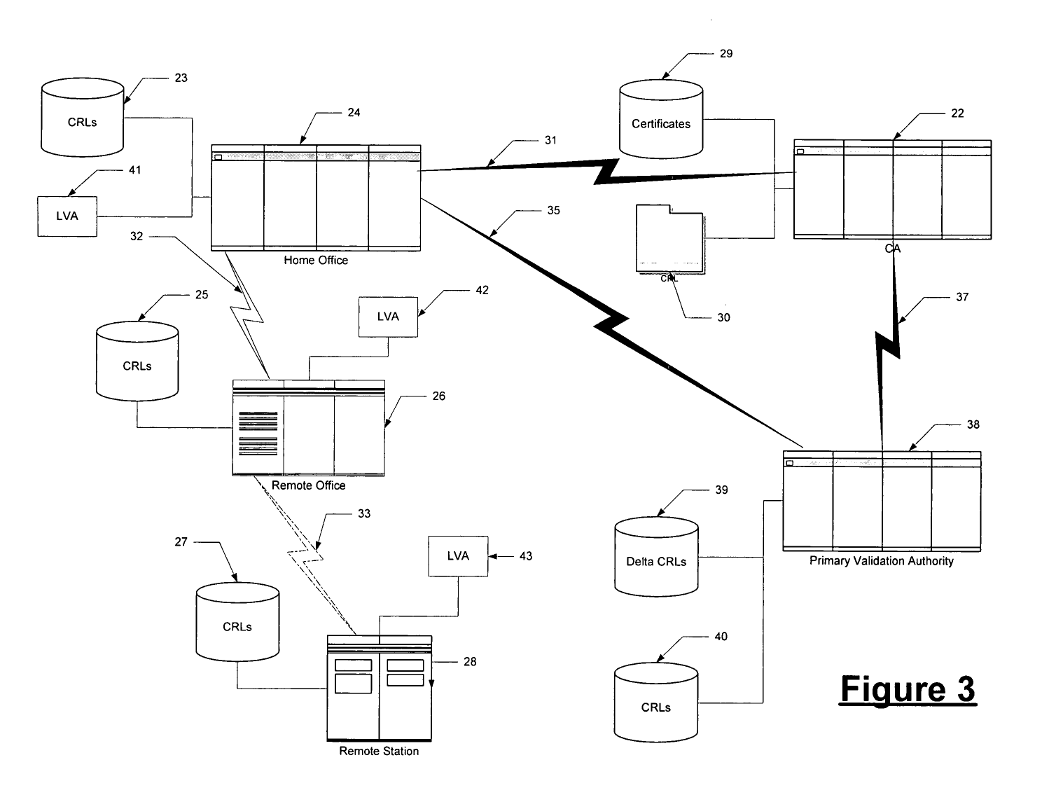

FIG. 3 illustrates the distributed network arrangement of FIG. 1 as configured to employ CRL updating and validation in accordance with the invention. The illustrated arrangement includes the enterprise components 24, 26, 28, the CA 22, and validation authority components 38, 41, 42, 43. The illustrated CA 22 is preferably similar to that discussed with reference to FIG. 1. A first communication link 31 is provided between the CA 22 and the enterprise home office 24. A second communication link 37 is provided between the CA 22 and a primary validation authority (PVA) 38. Each of the first and second communication links 31, 37 is preferably a high bandwidth communication link.

The PVA 38 is associated with a CRL database 40, similar to that employed by components of the enterprise discussed with reference to FIG. 1, and a DeltaCRL database 39, which will be discussed in further detail below. Each of the enterprise components is associated with a CRL database 23, 25, 27 and a local validation authority (LVA) 41, 42, 43. Communication links 32, 33 are provided between the enterprise components 24, 26, 28 as discussed with reference to FIG. 1.

In operation, the PVA 38 communicates with various CAs to receive updated CRLs. In the illustrated embodiment, the PVA 38 receives newly issued CRLs from the CA 22. As discussed above, the communication link between the PVA 38 and the CA 22 is a high bandwidth link which allows for efficiently communicating entire CRLs. The PVA 38 examines each new CRL from the CA 22 and generates a data item referred to herein as a DeltaCRL. The DeltaCRL is the difference between the last known CRL of the CA 22 and the present, newly issued, CRL. The DeltaCRL is generated to as to allow each LVA to generate an updated CRL from a previous version of the same CRL. A DeltaCRL is preferably generated for every new CRL received from the CA 22. Hence, if the CA 22 has updated its CRL 15 times, there will be 15 DeltaCRLs available, corresponding to the difference between each temporally sequential version of the CRL. This series of periodically ordered DeltaCRLs provides a chain starting from a first base CRL, which is available to all modules of a distributed PKI system. Hence, in the system of the present invention, the current CRL is made available by reference to the chain of DeltaCRLs eminating from a known base CRL. Thus, the system of the present invention provides increased reliability by making available an entire DeltaCRL chain which allows for reproducing a current CRL from any previous CRL within the chain's timeframe.

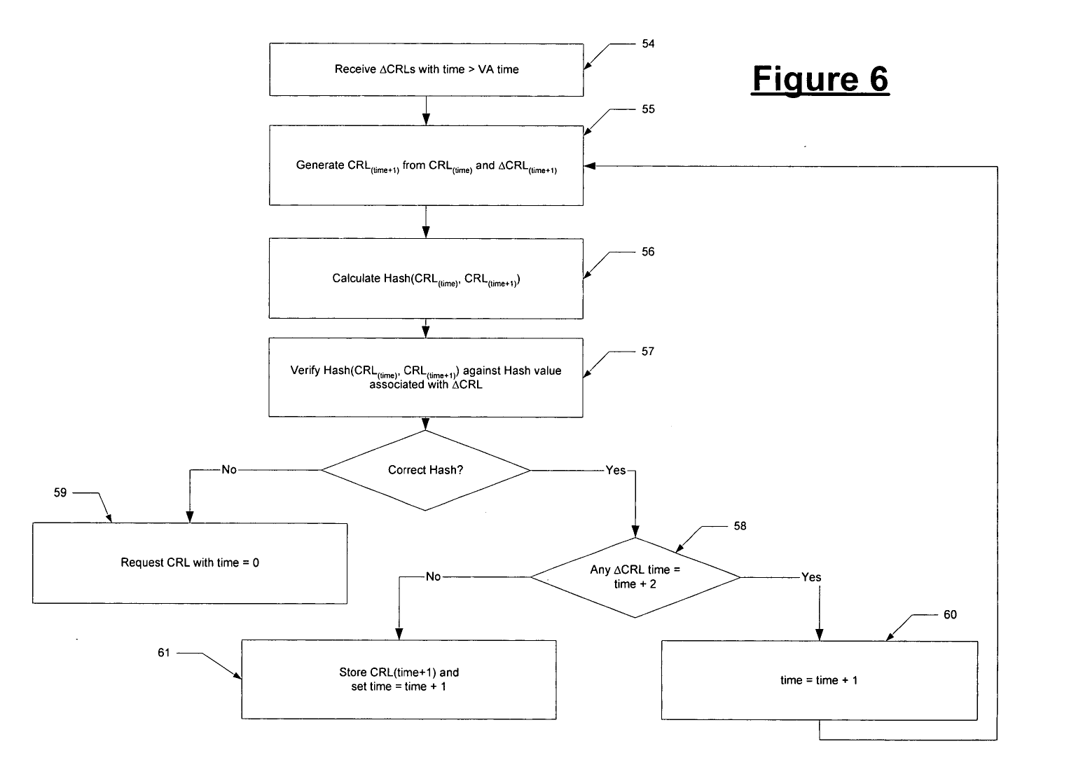

In the illustrated embodiment, the DeltaCRL generated by the PVA 38 is transmitted to the LVA 41 servicing the home office 24. The LVA 41 employs the DeltaCRL to generate an updated CRL and store the updated CRL in the local CRL database 23. The DeltaCRL is also stored in the home office CRL database 23 and is made available to lower, slave, nodes of the enterprise, such as the illustrated remote office 26. Within each such slave node, the DeltaCRL is received and used to construct an updated CRL. Details of the operation of the LVAs 41, 42, 43 in constructing an updated CRL are provided below with reference to FIG. 6. Each LVA 41, 42, 43 preferably stores a plurality of DeltaCRLs which preferably correspond to earlier versions of the CRL than the current CRL version stored in the CRL database 23, 25, 27. This allows any slave LVAs, which may be several versions behind, to receive all subsequent DeltaCRLs and construct an updated CRL.

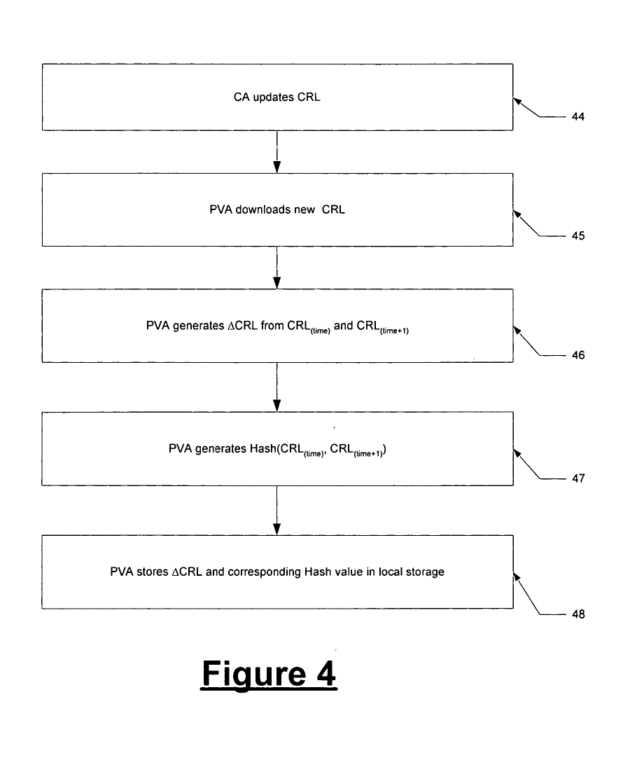

FIG. 4 illustrates steps taken by the illustrated PVA 38 in generating DeltaCRLs. The CA 22 updates its CRL when certificates are revoked or otherwise affected by CA operations (step 44). The PVA downloads the updated CRL from the CA 22 (step 45). The PVA 38 generates a DeltaCRL from the downloaded updated CRL and the existing CRL corresponding to the CA 22 (step 46). The DeltaCRL includes data which allows the LVAs to generate an updated CRL from a previous version. Hence, each DeltaCRL(time+1) is associated with a CRL(time) and CRL(time+1) where the periodic increments of (time) depend on the frequency of CRL updating by the particular CA. In addition to generation the DeltaCRL(time+1), the PVA 38 generates a self validating indicator by computing a hash function that refers to CRL(time) and CRL(time+1) (step 47). The resultant hash value of (time+1)is stored along with the DeltaCRL of (time+1) in the DeltaCRL database of the PVA 38 (step 48).

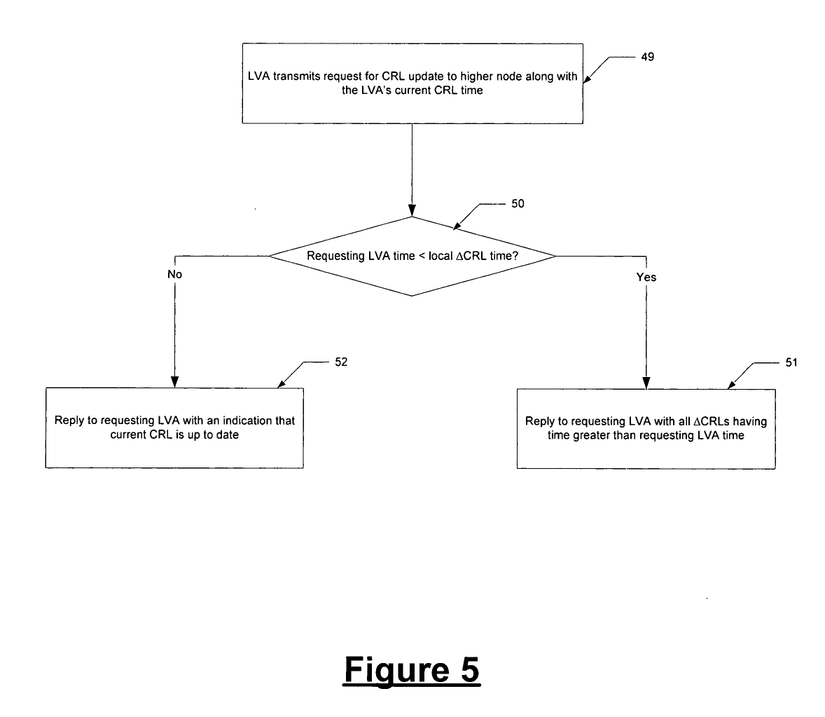

FIG. 5 illustrates the steps taken by a node querying for an updated CRL. The illustrated steps are preferably executed by all nodes of the enterprise, including the control home office 24. As may be appreciated, certain nodes are likely to query the PVA 38, or a higher node for updated CRL data more frequently than other nodes, depending on bandwidth availability and processing power. Accordingly, each LVA is configured to request CRL updates in accordance with its operating environment and the available communication bandwidth. In general, each slave LVA transmits a CRL update request to a master LVA or to the PVA 38 (step 49). The transmitted request preferably includes an indication of which base CRL, or time, is stored in the local CRL database of the requesting LVA. The higher node, for example the home office 24, determines whether it has a DeltaCRL available which is subsequent in time to the version of the CRL at the lower node, i.e., local time>requestor time (step 50). If the requesting node version is up to date, i.e., there are no subsequent DeltaCRLs available at the higher node, the higher node transmits an indication to the lower node that the present CRL version is up to date(step 52). If the requesting node version is not up to date, the higher node transmits all DeltaCRLs it has available, which have a associated time subsequent to the time of the CRL at the requesting node (step 51). As discussed above, the corresponding hash value is transmitted along with each DeltaCRL.

As may be appreciated, the present mechanism for distributed PKI requires a level of trust between nodes in the PKI environment. An LVA must ensure that the higher level LVA, from which DeltaCRLs are received, is a trusted master node. Hence, the master LVA signs the DeltaCRLs before transmission to the slave LVA. If the DeltaCRLs are not signed, or there are other flaws associated with the trust mechanism, the slave LVA preferably rejects the transmitted DeltaCRLs.

FIG. 6 is a flow diagram illustrating steps taken by a LVA of the invention to construct an updated CRL from a received DeltaCRL. As discussed above, the LVA receives all DeltaCRLs for a particular CA in response to a request by the LVA for updated CRL data subsequent to a given time (step 54). Hence, the received DeltaCRLs have an associated time that is greater than the current CRL time of the LVA. The LVA assembles updated CRLs by sequentially applying the DeltaCRLs to a base CRL of the current time. The LVA generates a first updated CRL (time+1) by applying a DeltaCRL (time+1) to CRL (time) by employing a CRL updating algorithm (step 55). The LVA further calculates a hash function based on the previous CRL and the updated CRL (step 56). As is known in the art, a hash function is a known formula that is has a known dependency from its input data, which can be used to verify that the same data was present when identical hash values are computed. The LVA compares the computed hash value to the hash value associated with the DeltaCRL (time+1)(step 57). Hence, the LVA comparison assures, with some certainty, that the resultant CRL (time+1) is the same as the CRL (time+1) that was made available to the PVA which generated the DeltaCRL. The LVA submits a query to the CRL database searching for a DeltaCRL with a time equal to time+2, indicating the next DeltaCRL in the update sequence (step 58). If there are no more DeltaCRLs in the database for the particular CA, the LVA sets the current CRL time to time+1 and stores the resultant CRL (time+1) in the CRL database (step 61). This CRL will be employed to validate certificates from the associated CA until a new CRL is constructed during the next update period. If there is a subsequent DeltaCRL in the database, the LVA increments the applicable time to time+1 (step 60) and returns to the CRL generation step when an updated CRL is generated from the current CRL and the DeltaCRL of time+1 (step 55).

If, at any time, during processing the comparison of the calculated hash value to the hash value provided with the DeltaCRL, does not result in a positive match, the LVA generates an error indication. In response to the error indication, the LVA transmits a request to a higher node, requesting a complete copy of the most recent CRL (step 59). The LVA then receives an entire CRL, which consumes much more bandwidth than the DeltaCRL updates, as part of the error recovery procedure. The LVA stores the received updated CRL in the CRL database and sets the CRL time to the time associated with the stored CRL. Accordingly, the LVAs have available update CRL without receiving an entire CRL during each update period.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A method for updating CRL information between distributed components in a PKI environment, comprising:
sequentially receiving a plurality of periodically updated versions of a CRL associated with a certificate authority;
generating a plurality of DeltaCRL data elements by reference to sequentially adjacent CRL versions from the received CRL versions;
providing the DeltaCRLs to a node in a distributed PKI environment; and
the node sequentially applying the DeltaCRLs to a base CRL to provide increasingly updated versions of said CRL, the base CRL being a version of the CRL within the timeframe of said periodically updated sequence of CRLs.

2. The method of claim 1, further comprising generating a hash value corresponding to each DeltaCRL, the hash value generated by reference sequentially adjacent CRL versions from the received CRL versions.
